(19) United States
(12) Patent Application Publication
(10) Pub. No.: US 2015/0060367 A1
(43) Pub. Date: Mar. 5, 2015

(54) COAGULATION PROCESSING METHOD, COAGULATION PROCESSING UNIT, AND WATER PROCESSING APPARATUS

(71) Applicant: Hitachi, Ltd., Tokyo (JP)

(72) Inventors: Satoshi ISHII, Tokyo (JP); Kenji OKISHIRO, Tokyo (JP); Hiroshi SASAKI, Tokyo (JP)

(73) Assignee: Hitachi, Ltd.

(21) Appl. No.: 14/448,260

(22) Filed: Jul. 31, 2014

(30) Foreign Application Priority Data
Aug. 28, 2013 (JP) 2013-176183

(51) Int. Cl. C02F 1/52; C02F 1/44; C02F 1/54

(52) U.S. Cl. CPC C02F 1/5236; C02F 1/54; C02F 1/5209; C02F 1/441; C02F 2103/08
USPC 210/709; 210/702; 210/723; 210/728; 210/143; 210/724

(57) ABSTRACT

The present invention provides a coagulation processing method capable of adding a sufficiently-dissolved coagulant aqueous solution to being processed water and materializing high-efficiency coagulation processing, a coagulation processing unit, and a water processing apparatus.

A coagulation processing unit includes a coagulant aqueous solution storage tank 1 to have a stirrer 5 and store a coagulant aqueous solution, a particle size distribution measurement device 50 to measure the particle size distribution of the coagulant aqueous solution in the coagulant aqueous solution storage tank 1, a coagulation tank 11 to mix being processed water with an added coagulant aqueous solution and form a coagulation, a coagulation removing section 9 to remove the coagulation from the being processed water containing the coagulation, and a control section 6 to control the stirrer 5 so that a median size in the particle size distribution of the coagulant aqueous solution may be not more than 1.0 μm on the basis of a measured particle size distribution.

### CLAIM OF PRIORITY

The present application claims priority from Japanese Patent application serial No. 2013-176183, filed on Aug. 28, 2013, the contents of which are hereby incorporated by reference into this application.

### FIELD OF THE INVENTION

The present invention relates to a coagulation processing method for adding a coagulant to being processed water and forming a coagulation, a coagulation processing unit, and a water processing apparatus having the coagulation processing unit.

### BACKGROUND OF THE INVENTION

As water-purification technologies to produce drinking water and utility water from natural water such as river water, chemical methods such as a coagulating sedimentation method and physical methods such as a sand filtration method have been considered.

Meanwhile in recent years, water shortage is a challenge in all the countries of the world including Middle East and Asia. In response to that, a seawater desalination technology to produce drinking water and utility water by desalinating seawater attracts attention and begins to be practically used. As a method for desalinating seawater, an evaporation method of obtaining fresh water by heating the seawater, thus evaporating water, and cooling the vapor has been used. The evaporation method however has a poor energy efficiency and is costly and hence a more efficient method has been desired. At present, a reverse osmosis method of obtaining fresh water by using a reverse osmosis membrane (RO membrane) and desalinating seawater through membrane filtration comes to be a main stream. In order to prevent an RO membrane from being polluted, it is necessary to apply appropriate preprocessing for removing suspended matters, organic matters, etc. before seawater is applied to the RO membrane. As a method of the preprocessing, membrane filtration by using an ultrafiltration (UF) membrane or a microfiltration (MF) membrane, the use of an absorbent such as activated carbon, or the use of a coagulant is studied in the same way as water purification processing.

As typical coagulants for sewage treatment or water purification processing, inorganic coagulants using polyvalent metallic ions (cations) comprising polyaluminum chloride (PAC) or iron chloride, polymer coagulants using water-soluble polymers having polyvalent ions, and the like are named. Such a coagulant removes electrically-charged impurities contained in water by coagulation and sedimentation. Meanwhile, in the case of obtaining an insufficient effect even when either an inorganic coagulant or an organic coagulant is used, it is sometimes possible to enhance the coagulation effect by using an inorganic coagulant and an organic coagulant in combination.

JP-A No. 2002-136809 describes an apparatus to produce an aqueous solution when a polymer coagulant is used and discloses an apparatus having a mechanism of measuring the concentration of the dissolved polymer coagulant aqueous solution.

JP-A No. 2008-264723 discloses a method of coagulating impurities by adding an organic coagulant and an inorganic coagulant simultaneously or in this sequence and adjusting pH when the impurities in water such as seawater or river water are removed.

JP-A No. H10-225682 discloses a method of removing boron by adjusting pH with a pH adjuster and then adding a coagulant for removing boron when seawater is purified.

In any of JP-A No. 2002-136809, JP-A No. 2008-264723, and JP-A No. H10-225682 however, the function of measuring a particle size distribution in a coagulant aqueous solution is not provided and it is impossible to judge whether or not a coagulant dissolves sufficiently in an aqueous solution. Consequently, if a polymer coagulant is used as the coagulant and coagulation processing is applied by adding an insufficiently-dissolved coagulant aqueous solution, the coagulation efficiency lowers and the coagulant is consumed more than necessary.

The present invention provides a coagulation processing method capable of materializing highly-efficient coagulation processing by adding a sufficiently-dissolved coagulant aqueous solution to processed water, a coagulation processing unit, and a water processing apparatus.

### SUMMARY OF THE INVENTION

In order to solve the problems, a coagulation processing method of the present invention comprises a step for adding one or more kinds of coagulant aqueous solutions to be processed water containing impurities, thus forming a coagulation, and a step for removing the formed coagulation, thereby the impurities in being processed water are removed, and is characterized in that controls a median size in the particle size distribution of the coagulant aqueous solution to not more than 1.0 μm.

Further, a coagulation processing unit of the present invention is characterized in that comprises a coagulant aqueous solution storage tank having a stirrer to store a coagulant aqueous solution, a particle size distribution measurement device to measure the particle size distribution of the coagulant aqueous solution in the coagulant aqueous solution storage tank, a coagulation tank to mix being processed water with an added coagulant aqueous solution and form a coagulation, a coagulation removing section to remove the coagulation from the being processed water containing the coagulation, and a control section to control the stirrer so that a median size in the particle size distribution of the coagulant aqueous solution may be not more than 1.0 μm on the basis of a measured particle size distribution.

According to the present invention, it makes it possible to provide a coagulation processing method capable of adding a sufficiently-dissolved coagulant aqueous solution to be processed water and materializing highly-efficient coagulation processing, a coagulation processing unit, and a water processing apparatus.

When a polymer coagulant is used as a coagulant for example, since it is possible to disperse the coagulant uniformly in being processed water and improve coagulation processing efficiency, it is possible to reduce a medical agent in a coagulation process and reduce the operation cost of a water processing apparatus.

Other problems, configurations, and effects than described above will be obvious by explaining the following embodiments.

### BRIEF DESCRIPTION OF THE DRAWINGS

FIG. 1 is a general configuration diagram of a water processing apparatus having a coagulation processing unit according to the present invention;

FIG. 2 is another general configuration diagram of a water processing apparatus having a coagulation processing unit according to the present invention;

FIG. 3 is still another general configuration diagram of a water processing apparatus having a coagulation processing unit according to the present invention;

FIG. 4 is yet another general configuration diagram of a water processing apparatus having a coagulation processing unit according to the present invention;

FIG. 5 is a table explaining the relationship between a particle size distribution and the trap of impurities;

FIG. 6 is a table explaining the relationship between a particle size distribution and a processed water quality at each of the embodiments;

FIG. 7 is a table explaining the relationship between a particle size distribution and a processed water quality at each of the comparative examples; and

FIG. 8 is a graph showing the relationship between an acidic sugar rejection ratio and the ascension rate of clogging (filtration pressure).

### DETAILED DESCRIPTION OF THE PREFERRED EMBODIMENTS

A coagulation processing method, a coagulation processing unit, and a water processing apparatus according to an embodiment of the present invention are explained hereunder. The present invention is characterized by controlling a median size (d50) in the particle size distribution of a polymer coagulant aqueous solution used for coagulation processing to not more than 1.0 μm. Here, a median size means the size of a particle located in the center when particles are aligned in the order of size and is generally described as d50. By injecting a polymer coagulant aqueous solution in the state of being dissolved in sufficiently small particle sizes, it is possible to disperse a coagulant into being processed water swiftly and uniformly, and to apply coagulation processing of a high efficiency. It is still better to control the pH of a coagulant aqueous solution to an acid state (not more than pH 2, preferably not more than pH 1) when being processed water is salty water of a high concentration such as seawater. This is caused by the dissociation state of a coagulant and is explained on the basis of an anionic polymer. A carboxyl radical included in an ordinary anionic polymer coagulant exists in water in such an equilibrium state as described below. In an acid region, the equilibrium shifts toward the left and the dissociation of the carboxyl radical is inhibited. That is, when a polymer coagulant aqueous solution is acidized, a carboxyl radical of an anionic polymer in an aqueous solution is in an undissociated state. Then when the polymer coagulant aqueous solution is added to salty water of a high concentration as it is, divalent ions (Mg, Ca, etc.) in being processed water can be inhibited from combining and it does not happen that a coagulation is formed instantaneously. As a result, it is desirably estimated that a polymer coagulant coagulating before targeted impurities are trapped can be reduced to the greatest possible extent and a medical agent and a cost can be reduced.

—COOH⇄—COO⁻+H⁺ (Formula 1)

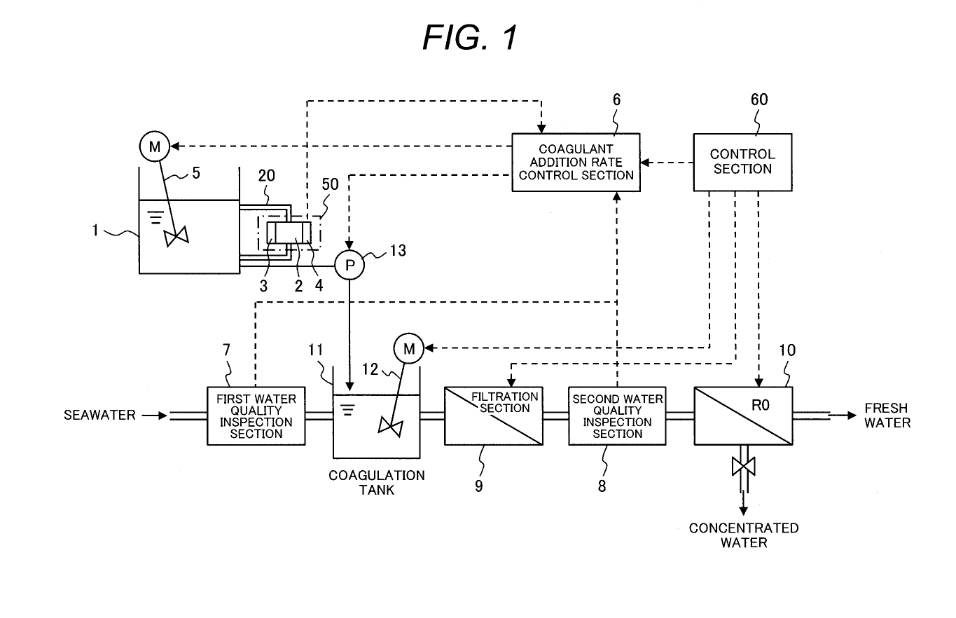

FIG. 1 is a general configuration diagram of a water processing apparatus having a coagulation processing unit according to the present invention. The present invention: is explained hereunder on the basis of the case of using a seawater desalination apparatus as a water processing apparatus; but is not limited to the case; and is applicable likewise to a processing apparatus for industrial effluent and a processing apparatus for sewage such as domestic sewage. In FIG. 1 further, the flow of water is represented by sold arrows and signal lines (control lines) are represented by dotted lines.

As shown in FIG. 1, a water processing apparatus according to the present invention includes a coagulant aqueous solution storage tank 1, a first water quality inspection section 7 to measure the quality of seawater to be processed water, a coagulation tank 11 to add a polymer coagulant aqueous solution to the being processed water and to apply coagulation processing, a filtration section 9 to separate and remove a coagulation from the being processed water after coagulation reaction, a second water quality inspection section 8 to measure the quality of the being processed water after the coagulation is removed, a reverse osmosis membrane unit (hereunder referred to as an RO membrane unit) 10 to remove a saline matter from the being processed water from which the coagulation is removed, and a control section 60 to control them. The RO membrane unit 10 removes ions such as chloride ions and sodium ions from the being processed water from which the coagulation is removed. Further, the filtration section 9 is configured by appropriately placing any one or a combination of a sedimentation tank (sedimentation section), an ultrafiltration section, a microfiltration section, a sand filtration tank (sand filtration section), and a multimedia filtration section, for example. Then the filtration section 9 separates and removes the coagulation produced by making impurities in the being processed water trapped by a coagulant in the coagulation tank 11 from the being processed water. Here, in the general configuration of the water processing apparatus shown in FIG. 1, the configuration excluding the RO membrane unit 10 is called a coagulation processing unit.

The coagulant aqueous solution storage tank 1 has a stirrer 5 to stir a polymer coagulant aqueous solution, a branched channel 20 used for measuring a particle size distribution, and a particle size distribution measurement device 50 installed at the branched channel 20 and used for measuring the particle size distribution of the polymer coagulant aqueous solution. The particle size distribution measurement device 50 includes a flow cell 2 to flow the polymer coagulant aqueous solution, a laser irradiation section 3 to irradiate the polymer coagulant aqueous solution flowing in the flow cell 2 with a laser, and a detection section 4 disposed so as to interpose the flow cell 2 and face the laser irradiation section 3. The detection section 4 detects a scattered light intensity by receiving scattered light generated by irradiating the coagulant in the polymer coagulant aqueous solution with a laser and converting the light into electricity. Then the detection section 4 obtains the distribution of the particle sizes of the coagulant in the polymer coagulant aqueous solution on the basis of a scattered light intensity distribution, and outputs the distribution to a coagulant addition rate control section 6. The coagulant addition rate control section 6 thereby obtains a median size (d50) in the particle size distribution of the polymer coagulant aqueous solution in the coagulant aqueous solution storage tank 1.

Although the particle size distribution measurement device 50 is explained here on the basis of the case of measuring a particle size distribution by a dynamic light scattering method at a flow cell 2, a laser irradiation section 3, and a detection section 4, in addition to the method, particle size distribution measurement methods such as a laser diffraction method, a picture imaging method, and a gravity sedimentation method are known for example. The laser diffraction method is a method of obtaining particle sizes from the intensity distributions of diffraction light and scattered light obtained by irradiating particles with a laser. Further, the picture imaging method is a method of obtaining a picture of particles with an optical microscope, an electron microscope, or the like and obtaining the sizes of the particles from the picture image. The gravity sedimentation method is a method of dispersing an analysis sample uniformly in a solvent and obtaining a particle size distribution from the sedimentation velocities of the particles. Furthermore, although a particle size distribution measurement device 50 includes a flow cell 2, a laser irradiation section 3, and a detection section 4 in the present invention, the present invention is not limited to that. For example, it is also possible to, configure a particle size distribution measurement device 50 with a fiber for laser irradiation and a fiber for light receiving disposed closely so as to be perpendicular to it, and to install the particle size distribution measurement device 50 in a coagulant aqueous solution storage tank 1. On this occasion, it is unnecessary to install a branched channel 20 in the coagulant aqueous solution storage tank 1.

In FIG. 1 further, a stirrer 12 is installed in the coagulation tank 11 and the speed of stirring fins can be controlled by controlling the rotation frequency of a motor. That is, a stirring intensity is controllable. Here, a stirring intensity is determined from the capacity of a coagulation tank, the area of stirring fins, the rotation frequency of the stirring fins (stirring speed), and others but the stirring intensity is controlled by controlling the rotation frequency of the stirring fins because the capacity and the area of the stirring fins are constant.

The operation of a water processing apparatus shown in FIG. 1 is explained hereunder. Firstly, the quality of introduced being processed water is measured at a first water quality inspection section 7. The specific measurement items of the water quality are a total organic carbon (TOC) concentration, water temperature, pH, and turbidity for example. On this occasion, the particle size distribution of a polymer coagulant aqueous solution stored in a coagulant aqueous solution storage tank 1 is measured beforehand with a particle size distribution measurement device 50. Successively, after the being processed water is taken in a coagulation tank 11, a coagulant addition rate control section 6 controls a pump 13 and adds an optimum amount of polymer coagulant aqueous solution from the coagulant aqueous solution storage tank 1 to the coagulation tank 11 on the basis of the quality data of the being processed water and the data of the particle size distribution of the polymer coagulant aqueous solution measured at the first water quality inspection section 7 (feedforward control). After the polymer coagulant is sufficiently activated with a stirrer 12 in the coagulation tank 11, a coagulation is removed at a filtration section 9. Successively, the quality of the being processed water from which the coagulation is removed is measured at a second water quality inspection section 8. The coagulant addition rate control section 6 decides a highly precise and optimum addition quantity of a polymer coagulant aqueous solution and adds the quantity decided to the being processed water by feedback control on the basis of the water quality data measured at the second water quality inspection section 8 and the particle size distribution data of the polymer coagulant aqueous solution. The coagulant addition rate control section 6 stores the relationship of water quality data, the particle size distribution data of the coagulant aqueous solution, and an optimum addition quantity of a coagulant beforehand in a memory section not shown in the figure. Here, it is more desirable to configure the coagulant aqueous solution storage tank 1 so as to have a pH measurement mechanism and monitor and control the pH of the polymer coagulant aqueous solution, and install a mechanism allowing a pH adjuster to be added.

As a polymer coagulant in a polymer coagulant aqueous solution stored in a coagulant aqueous solution storage tank 1, any one of a polyacrylamide system coagulant, a polysulfonic acid system coagulant, a polyacrylic acid system coagulant, a polyacrylic acid ester system coagulant, a polyamine system coagulant, and a polymethacrylic acid coagulant can be used. In the case of a polymer having a carboxyl radical of a small acid dissociation constant in particular, the speed at which the polymer is ionized when added to seawater is low and hence impurities can be trapped more effectively.

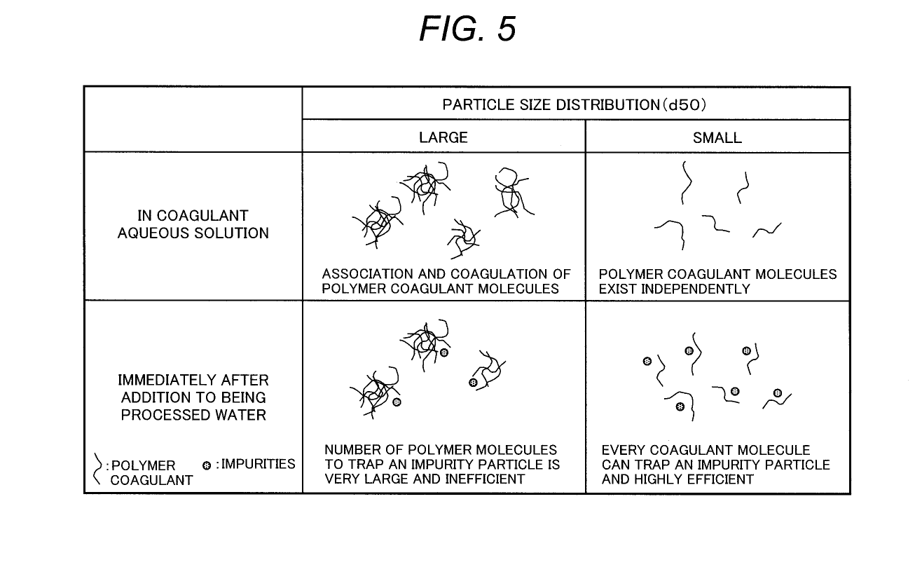

A mechanism of trapping impurities in being processed water by a polymer coagulant is explained hereunder. FIG. 5 is a table explaining the relationship between a particle size distribution and the trap of impurities.

In FIG. 5, when a median size (d50) in the particle size distribution of a polymer coagulant aqueous solution is small, a polymer coagulant dissolves sufficiently and uniformly and is added to being processed water in a coagulation tank 11 in the state where the polymer chains are separated from each other. In contrast, when a median size (d50) is large, a polymer coagulant dissolves insufficiently and is added to being processed water in a coagulation tank 11 in the state where an association is formed by entanglement between polymer coagulant molecules or the like. In FIG. 5, in the case of a small median size (d50) in comparison with the case of a large median size (d50), it is possible to trap more impurities in processed water by one polymer chain, thereby make the polymer chain act on more impurities in the being processed water, and to process the coagulation more efficiently. To that end, by processing coagulation while measuring the particle size distribution of a polymer coagulant aqueous solution and confirming that it is an appropriate particle size distribution, the coagulation processing can be more efficient. As a result, advantages including the reduction of a medical agent quantity caused by the optimization of a coagulant addition rate, the reduction in the risk of a harmful effect caused by excessive addition of a medical agent, and the like can be obtained.

Although the above explanations have been made on the basis of a polymer coagulant, the same consideration can be applied to an inorganic solvent. That is, it is estimated that, if the median size (d50) of a coagulant aqueous solution is large, an inorganic coagulant does not ionize and is in the state of forming an association and a coagulation before it is added to being processed water and that leads to the lowering of the effect when the inorganic coagulant is added to the being processed water. For that reason, when two kinds of coagulants of an inorganic coagulant and a polymer coagulant are used as the coagulants for example, it is desirable to measure the particle size distributions of both the inorganic coagulant and the polymer coagulant in an aqueous solution. In the case of a polymer coagulant in particular, the influence is conspicuous and hence the effect is large.

Explanations in the case of applying a polymer coagulant to high-concentration salty water are made hereunder on the basis of applying an anionic polymer coagulant. When a carboxyl radical is added in a dissociated state as shown in Formula 1, instantaneously the carboxyl radical combines with microflocs, Mg, Ca, etc. in seawater that is salty water of a high concentration by electrostatic interaction and forms a coagulation. In contrast, when the pH of an aqueous solution of an anionic polymer coagulant is lowered, the equilibrium in Formula 1 shifts toward the right and a carboxyl radical is added to seawater in an undissociated state. On that occasion, unlike the above case, a time lag is caused from the addition of a coagulant to the formation of a coagulation and the anionic polymer can physically trap more microflocs in the meantime. As a result, the efficiency of a coagulant can be improved by lowering the pH of an aqueous solution containing an anionic polymer coagulant. Further, when a steady state is reached, the equilibrium constant of Formula 1 is determined by the pH of being processed water, thus the pH of the being processed water also influences coagulation efficiency, and hence it is possible to form a coagulation more effectively by adding a pH adjuster when a polymer coagulant is added.

A configuration of measuring the quality of introduced being processed water (seawater) at a first water quality inspection section 7 and measuring the quality of the being processed water after a coagulation is removed at a second water quality inspection section 8 is shown in FIG. 1 and the measurement of water quality is explained hereunder.

Information on water quality (water quality data) of being processed water and water quality data of processing water are obtained by sensing substances (total organic carbon (TOC) and turbidity) contained in introduced being processed water. Feedback and feedforward control is carried out by using the water quality data measured at the first and second water quality inspection sections 7 and 8. A coagulant addition rate control section 6 decides the addition quantities of various coagulants suitable for the quality of the introduced being processed water (water quality data measured at the first water quality inspection section 7). As a result, it is possible to materialize a maximum coagulant efficiency by the optimization of the addition quantities of the coagulants, prevent excessive addition of the coagulants and inhibit unnecessary sludge from being generated, and to optimize the operation cost of a water processing plant.

The measured water quality data, besides the above data, are water temperature, pH, electroconductivity, protein, saccharide (neutral sugar, acidic sugar), adenosine triphosphate (ATP) activity, and others and an index of an organic component or an inorganic component contained in the processed water that is estimated to influence the fouling (clogging) of an RO membrane unit 10 may desirably be included in the water quality data to be measured.

In FIG. 1, a first water quality inspection section 7 and a second water quality inspection section 8 are installed at the front stage of a coagulation tank 11 and at the rear stage of a filtration section 9, respectively. The purpose is to optimize coagulation processing with a high degree of accuracy. For simplification however, it is also possible to install either of the water quality inspection sections and carry out the evaluation of water quality and the control of a coagulant addition rate.

A coagulant addition rate control section 6 not only decides a quantity of a polymer coagulant aqueous solution added to being processed water in a coagulation tank 11 but also controls the stirring intensity of a stirrer 5 installed in a coagulant aqueous solution storage tank 1 so that a median size (d50) in the particle size distribution of the polymer coagulant aqueous solution stored in the coagulant aqueous solution storage tank 1 may be not more than 1.0 μm. Here as stated earlier, a stirring intensity is determined by the capacity of a tank, the area of stirring fins, the rotation frequency of the stirring fins (stirring speed), and others but the stirring intensity is controlled by controlling the rotation frequency of the stirring fins because the capacity and the area of the stirring fins are constant.

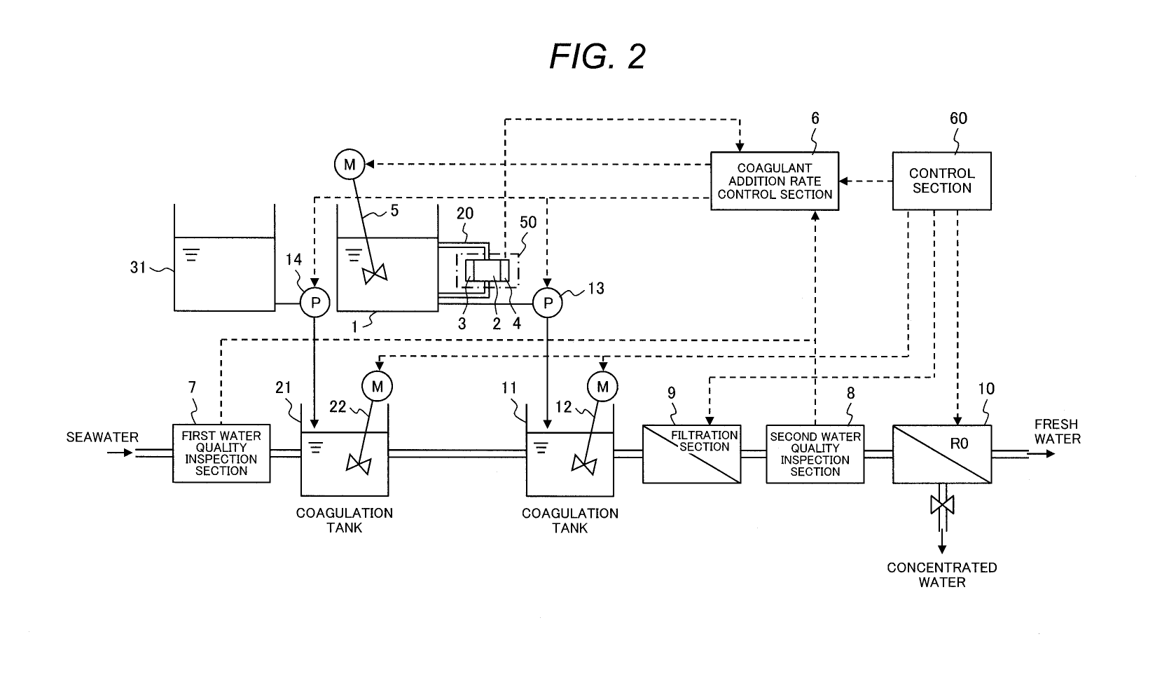

A water processing apparatus in the case of using two kinds of coagulants is explained hereunder. FIG. 2 is another general configuration diagram of a water processing apparatus having a coagulation processing section according to the present invention. Constituent components identical to FIG. 1 are represented by identical reference numerals. The water processing apparatus is configured by further installing a first coagulant aqueous solution storage tank 31 to store an inorganic coagulant aqueous solution and a coagulation tank 21 to add the inorganic coagulant aqueous solution to being processed water and process coagulation in the water processing apparatus explained in FIG. 1. The coagulation tank 21 to add the inorganic coagulant aqueous solution and process coagulation is referred to as a first coagulation tank and the coagulation tank 11 to add a polymer coagulant aqueous solution and process coagulation is referred to as a second coagulation tank hereunder. As the inorganic coagulant, any one of aluminum sulphate, ferric chloride, ferric sulfate, aluminum chloride, aluminum sulfate, and polyaluminum chloride is used for example.

In the configuration of the water processing apparatus shown in FIG. 2, it is desirable to install particle size distribution measurement devices 50 in both the first coagulant aqueous solution storage tank 31 to store an inorganic coagulant aqueous solution and the second coagulant aqueous solution storage tank 1 to store a polymer coagulant aqueous solution but here the configuration of installing a particle size distribution measurement device 50 only in the second coagulant aqueous solution storage tank 1 is adopted. The operations of the water processing apparatus shown in FIG. 2 are explained. An inorganic coagulant aqueous solution stored in the first coagulant aqueous solution storage tank 31 is fed to the first coagulation tank 21 through a pump 14. Further, a polymer coagulant aqueous solution stored in the second coagulant aqueous solution storage tank 1 is fed to the second coagulation tank 11 connected to the rear stage of the first coagulation tank 21 through a pump 13. A stirrer 22 and a stirrer 12 are installed in the first coagulation tank 21 and the second coagulation tank 11 respectively and the speeds of stirring fins can be controlled by controlling the rotation frequencies of motors. Here, the inorganic coagulant aqueous solution and the polymer coagulant aqueous solution are stored in the first coagulant aqueous solution storage tank 31 and the second coagulant aqueous solution storage tank 1 in the states where the median sizes (d50) in particle size distributions are not more than 1.0 μm, respectively.

When an inorganic coagulant aqueous solution is fed to the first coagulation tank 21, rapid stirring is applied for a given period of time with the stirrer 22 and the being processed water is sent to the second coagulation tank 11 at the rear stage after the inorganic coagulant aqueous solution is added and the being processed water is stirred for a given period of time. Successively, a polymer coagulant aqueous solution is added to the being processed water in the second coagulation tank 11 and the being processed water is stirred slowly for a given period of time with the stirrer 12. The being processed water stirred slowly for a given period of time is sent to the filtration section 9, a coagulation formed in the being processed water is separated and removed, and the being processed water is separated into concentrated water and fresh water by filtration at the RO membrane unit 10. By applying rapid stirring at the first coagulation tank 21 and applying slow stirring at the second coagulation tank 11 in this way, it is possible to increase the particle size of flocs that are the coagulation in the being processed water and improve the coagulation performance. Here, an addition quantity of an inorganic coagulant aqueous solution and an addition quantity of a polymer coagulant aqueous solution are decided by the water quality data obtained from the first water quality inspection section 7, the water quality data obtained from the second water quality inspection section 8, and a median size (d50) in the particle size distribution of a polymer coagulant aqueous solution obtained from the particle size distribution measurement device 50 in the same manner as shown in FIG. 1.

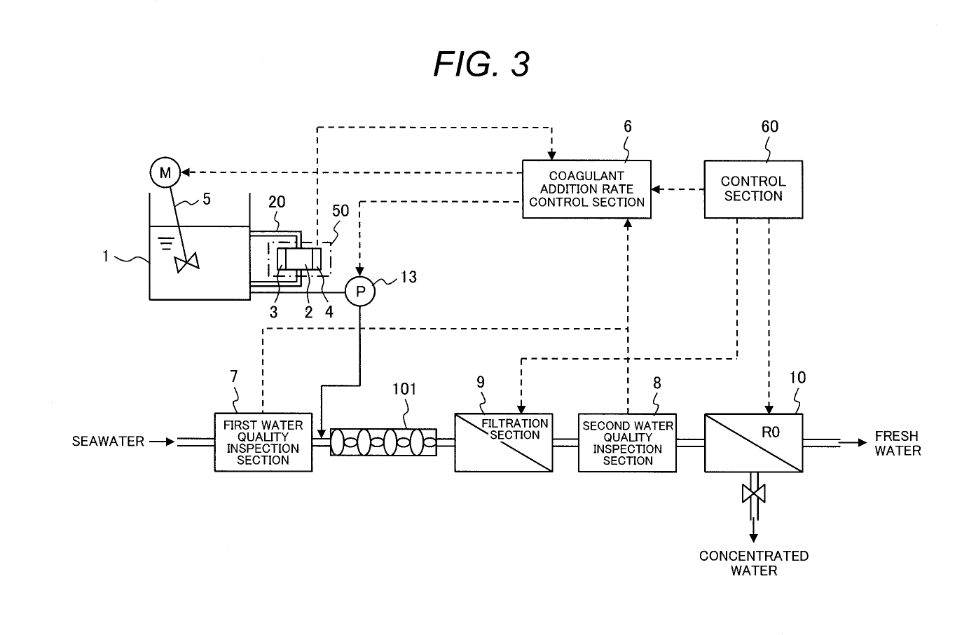

A configuration of using a means for mixing a coagulant in-line in place of a coagulation tank as shown in FIG. 1 or 2 is explained hereunder. FIG. 3 is still another general configuration diagram of a water processing apparatus having a coagulation processing unit according to the present invention. A water processing apparatus as shown in FIG. 3 is configured so as to be provided with an in-line mixer 101 in place of the coagulation tank 11 and the stirrer 12 as shown in FIG. 1 and add a polymer coagulant aqueous solution to being processed water at the front stage of the in-line mixer 101 through a pump 13. Specifically, a port allowing a polymer coagulant aqueous solution to be injected is formed at a pipe connected to the inlet part of the in-line mixer 101. The in-line mixer 101 has two spiral partitions facing each other in the interior for example. Flocs that are a coagulation are formed by applying a shear stress to the being processed water flowing in the interior by the two spiral partitions facing each other and mixing the polymer coagulant and impurities contained in the being processed water. In the same manner as shown in FIG. 1, a coagulant addition rate control section 6 decides an addition quantity of the polymer coagulant aqueous solution on the basis of water quality data obtained from a first water quality inspection section 7, water quality data obtained from a second water quality inspection section 8, and a median size (d50) in the particle size distribution of the polymer coagulant aqueous solution obtained from a particle size distribution measurement device 50. When an in-line mixer 101 is used in this way, it is necessary to set a pipe length or a pipe diameter in order to secure reaction time after mixture, namely time required for the polymer coagulant to trap impurities in the being processed water.

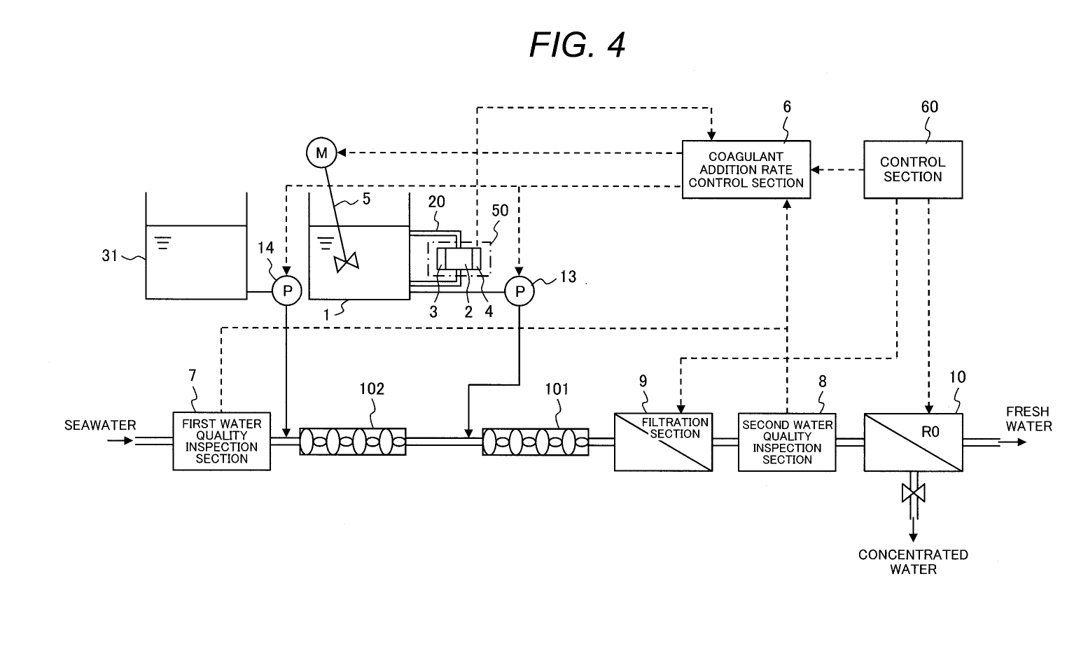

Further, FIG. 4 is yet another general configuration diagram of a water processing apparatus having a coagulation processing unit according to the present invention. In a water processing apparatus shown in FIG. 4, an in-line mixer 102 and an in-line mixer 101 are installed in place of the first coagulation tank 21 and the stirrer 22 and the second coagulation tank 11 and the stirrer 12 shown in FIG. 2, respectively. The structure itself of each of the in-line mixers is the same as FIG. 3 and hence the explanations are omitted. In the configuration shown in FIG. 4, an inorganic coagulant aqueous solution is added to being processed water through a pump 14 at the front stage of the in-line mixer 102 and a polymer coagulant aqueous solution is added to the being processed water through a pump 13 at a pipe section connecting the in-line mixer 102 to the in-line mixer 101. Here, a coagulant addition rate control section 6 decides an addition quantity of an inorganic coagulant aqueous solution and an addition quantity of a polymer coagulant aqueous solution in the same manner as FIG. 2. Further, it is necessary to set a pipe length or a pipe diameter in order to secure reaction time after mixture in the same way as the configuration shown in FIG. 3.

By a water processing apparatus according to the present invention shown in FIGS. 1 to 4, it is possible to store a coagulant aqueous solution having a median size (d50) in a particle size distribution of not more than 1.0 μm and improve the efficiency of the coagulation processing. Further, it is possible to materialize a maximum coagulant efficiency by the optimization of a coagulant addition rate, prevent excessive addition of a coagulant and unnecessary sludge from being generated, and to optimize the operation cost of the water processing apparatus.

Here, the shapes and materials of coagulant aqueous solution storage tanks 1 and 31 used in a water processing apparatus according to the present invention shown in FIGS. 1 to 4 are not particularly limited as long as they can store coagulants. Furthermore, since the pH of a coagulant aqueous solution influences the efficiency of coagulation processing, it is desirable to install a pH measurement mechanism and a pH adjuster addition mechanism.

Embodiments according to the present invention are specifically explained together with comparative examples hereunder.

### Embodiment 1

In the present Embodiment, the configuration of a water processing apparatus shown in FIG. 2 is used, a ferric chloride aqueous solution of 3.8% concentration is used as an inorganic coagulant aqueous solution stored in a coagulant aqueous solution storage tank 31, and a polyacrylic acid-polyacrylamide copolymer aqueous solution of 0.1% concentration is used as a polymer coagulant aqueous solution stored in a coagulant aqueous solution storage tank 1. Seawater is used as being processed water and a sand filtration tank capable of removing impurities having particle sizes of about 5 μm is used as a filtration section 9. pH is set at 5.1, the particle size distribution (d50) of the polymer coagulant aqueous solution is set at 1.0 μm, and, in order to verify the effect of coagulation processing, being processed water after subjected to sand filtration is taken and the total organic carbon concentration (TOC) and the acidic sugar concentration of the being processed water are evaluated. As a result of the evaluation, a TOC of 0.5 ppm and an acidic sugar rejection ratio of 80% are obtained as the processed water quality.

On this occasion, as Comparative Example 1, the particle size distribution (d50) of the polymer coagulant aqueous solution is changed to 3.0 μm and other conditions are unchanged. As a result, a TOC of 0.6 ppm and an acidic sugar rejection ratio of 40% are obtained as the being processed water quality.

### Embodiment 2

In the present Embodiment, the configuration of a water processing apparatus shown in FIG. 2 is used, a ferric chloride aqueous solution of 3.8% concentration is used as an inorganic coagulant aqueous solution stored in a coagulant aqueous solution storage tank 31, and a polyacrylic acid-polyacrylamide copolymer aqueous solution of 0.1% concentration is used as a polymer coagulant aqueous solution stored in a coagulant aqueous solution storage tank 1. Seawater is used as being processed water and a sand filtration tank capable of removing impurities having particle sizes of about 5 μm is used as a filtration section 9. pH is set at 5.1, the particle size distribution (d50) of the polymer coagulant aqueous solution is set at 0.7 μm, and, in order to verify the effect of coagulation processing, being processed water after subjected to sand filtration is taken and the total organic carbon concentration (TOC) and the acidic sugar concentration of the being processed water are evaluated. As a result of the evaluation, a TOC of 0.5 ppm and an acidic sugar rejection ratio of 82% are obtained as the being processed water quality.

On this occasion, as Comparative Example 2, the particle size distribution (d50) of the polymer coagulant aqueous solution is changed to 1.5 μm and other conditions are unchanged. As a result, a TOC of 0.6 ppm and an acidic sugar rejection ratio of 55% are obtained as the being processed water quality.

### Embodiment 3

In the present Embodiment, the configuration of a water processing apparatus shown in FIG. 2 is used, a ferric chloride aqueous solution of 3.8% concentration is used as an inorganic coagulant aqueous solution stored in a coagulant aqueous solution storage tank 31, and a polyacrylic acid-polyacrylamide copolymer aqueous solution of 0.1% concentration is used as a polymer coagulant aqueous solution stored in a coagulant aqueous solution storage tank 1. Seawater is used as being processed water and a sand filtration tank capable of removing impurities having particle sizes of about 5 μm is used as a filtration section 9. pH is set at 5.1, the particle size distribution (d50) of the polymer coagulant aqueous solution is set at 0.3 μm, and, in order to verify the effect of coagulation processing, being processed water after subjected to sand filtration is taken and the total organic carbon concentration (TOC) and the acidic sugar concentration of the being processed water are evaluated. As a result of the evaluation, a TOC of 0.4 ppm and an acidic sugar rejection ratio of 85% are obtained as the being processed water quality.

On this occasion, as Comparative Example 3, the particle size distribution (d50) of the polymer coagulant aqueous solution is changed to 1.1 μm and other conditions are unchanged. As a result, a TOC of 0.5 ppm and an acidic sugar rejection ratio of 72% are obtained as the processed water quality.

### Embodiment 4

In the present Embodiment, the configuration of a water processing apparatus shown in FIG. 2 is used, a ferric chloride aqueous solution of 3.8% concentration is used as an inorganic coagulant aqueous solution stored in a coagulant aqueous solution storage tank 31, and a polyacrylic acid aqueous solution of 0.1% concentration is used as a polymer coagulant aqueous solution stored in a coagulant aqueous solution storage tank 1. Seawater is used as being processed water and a sand filtration tank capable of removing impurities having particle sizes of about 5 μm is used as a filtration section 9. pH is set at 3.7, the particle size distribution (d50) of the polymer coagulant aqueous solution is set at 1.0 μm, and, in order to verify the effect of coagulation processing, being processed water after subjected to sand filtration is taken and the total organic carbon concentration (TOC) and the acidic sugar concentration of the being processed water are evaluated. As a result of the evaluation, a TOC of 0.5 ppm and an acidic sugar rejection ratio of 82% are obtained as the being processed water quality.

On this occasion, as Comparative Example 4, the particle size distribution (d50) of the polymer coagulant aqueous solution is changed to 3.0 μm and other conditions are unchanged. As a result, a TOC of 0.6 ppm and an acidic sugar rejection ratio of 42% are obtained as the being processed water quality.

### Embodiment 5

In the present Embodiment, the configuration of a water processing apparatus shown in FIG. 2 is used, a ferric chloride aqueous solution of 3.8% concentration is used as an inorganic coagulant aqueous solution stored in a coagulant aqueous solution storage tank 31, and a polyacrylic acid aqueous solution of 0.1% concentration is used as a polymer coagulant aqueous solution stored in a coagulant aqueous solution storage tank 1. Seawater is used as being processed water and a sand filtration tank capable of removing impurities having particle sizes of about 5 μm is used as a filtration section 9. pH is set at 3.7, the particle size distribution (d50) of the polymer coagulant aqueous solution is set at 0.7 μm, and, in order to verify the effect of coagulation processing, being processed water after subjected to sand filtration is taken and the total organic carbon concentration (TOC) and the acidic sugar concentration of the being processed water are evaluated. As a result of the evaluation, a TOC of 0.4 ppm and an acidic sugar rejection ratio of 86% are obtained as the being processed water quality.

On this occasion, as Comparative Example 5, the particle size distribution (d50) of the polymer coagulant aqueous solution is changed to 1.5 μm and other conditions are unchanged. As a result, a TOC of 0.6 ppm and an acidic sugar rejection ratio of 59% are obtained as the being processed water quality.

### Embodiment 6

In the present Embodiment, the configuration of a water processing apparatus shown in FIG. 2 is used, a ferric chloride aqueous solution of 3.8% concentration is used as an inorganic coagulant aqueous solution stored in a coagulant aqueous solution storage tank 31, and a polyacrylic acid aqueous solution of 0.1% concentration is used as a polymer coagulant aqueous solution stored in a coagulant aqueous solution storage tank 1. Seawater is used as being processed water and a sand filtration tank capable of removing impurities having particle sizes of about 5 μm is used as a filtration section 9. pH is set at 3.7, the particle size distribution (d50) of the polymer coagulant aqueous solution is set at 0.3 μm, and, in order to verify the effect of coagulation processing, being processed water after subjected to sand filtration is taken and the total organic carbon concentration (TOC) and the acidic sugar concentration of the processed water are evaluated. As a result of the evaluation, a TOC of 0.4 ppm and an acidic sugar rejection ratio of 90% are obtained as the being processed water quality.

On this occasion, as Comparative Example 6, the particle size distribution (d50) of the polymer coagulant aqueous solution is changed to 1.1 μm and other conditions are unchanged. As a result, a TOC of 0.5 ppm and an acidic sugar rejection ratio of 75% are obtained as the processed water quality.

### Embodiment 7

In the present Embodiment, the configuration of a water processing apparatus shown in FIG. 2 is used, a ferric chloride aqueous solution of 3.8% concentration is used as an inorganic coagulant aqueous solution stored in a coagulant aqueous solution storage tank 31, and a polyacrylic acid-polyacrylamide copolymer aqueous solution of 0.1% concentration is used as a polymer coagulant aqueous solution stored in a coagulant aqueous solution storage tank 1. Seawater is used as being processed water and a sand filtration tank capable of removing impurities having particle sizes of about 5 μm is used as a filtration section 9. pH is set at 1.0, the particle size distribution (d50) of the polymer coagulant aqueous solution is set at 1.0 μm, and, in order to verify the effect of coagulation processing, being processed water after subjected to sand filtration is taken and the total organic carbon concentration (TOC) and the acidic sugar concentration of the being processed water are evaluated. As a result of the evaluation, a TOC of 0.5 ppm and an acidic sugar rejection ratio of 83% are obtained as the being processed water quality.

On this occasion, as Comparative Example 7, pH is changed to 8.0 and other conditions are unchanged. As a result, a TOC of 0.6 ppm and an acidic sugar rejection ratio of 45% are obtained as the being processed water quality.

### Embodiment 8

In the present Example, the configuration of a water processing apparatus shown in FIG. 2 is used, a ferric chloride aqueous solution of 3.8% concentration is used as an inorganic coagulant aqueous solution stored in a coagulant aqueous solution storage tank 31, and a polyacrylic acid aqueous solution of 0.1% concentration is used as a polymer coagulant aqueous solution stored in a coagulant aqueous solution storage tank 1. Seawater is used as being processed water and a sand filtration tank capable of removing impurities having particle sizes of about 5 μm is used as a filtration section 9. pH is set at 1.0, the particle size distribution (d50) of the polymer coagulant aqueous solution is set at 1.0 μm, and, in order to verify the effect of coagulation processing, being processed water after subjected to sand filtration is taken and the total organic carbon concentration (TOC) and the acidic sugar concentration of the being processed water are evaluated. As a result of the evaluation, a TOC of 0.4 ppm and an acidic sugar rejection ratio of 86% are obtained as the being processed water quality.

On this occasion, as Comparative Example 8, pH is changed to 8.0 and other conditions are unchanged. As a result, a TOC of 0.6 ppm and an acidic sugar rejection ratio of 51% are obtained as the being processed water quality.

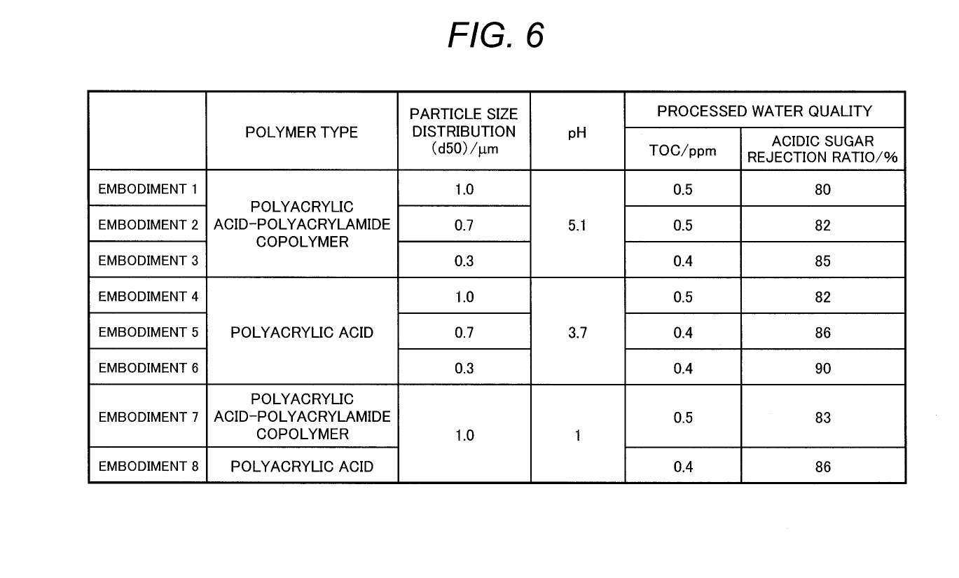

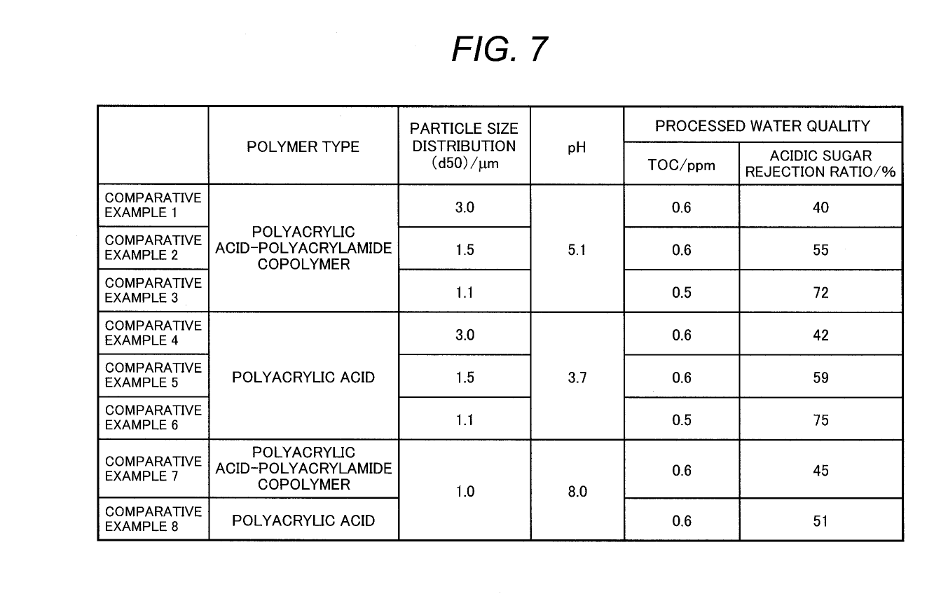

Embodiments 1 to 8 and Comparative Examples 1 to 8 stated above are summarized. FIG. 6 is a table explaining the relationship between a particle size distribution and a being processed water quality at each of the Examples and FIG. 7 is a table explaining the relationship between a particle size distribution and a being processed water quality at each of the comparative Examples.

In FIGS. 6 and 7, Embodiment 1 and Comparative Example 3, those being the cases of using a polyacrylic acid-polyacrylamide copolymer aqueous solution of 0.1% concentration as a polymer coagulant aqueous solution and setting pH at 5.1, are examined. Whereas the particle size distribution (d50) is 1.0 μm and the being processed water quality is a TOC of 0.5 ppm and an acidic sugar rejection ratio of 80% in Embodiment 1, the particle size distribution (d50) is 1.1 μm and the being processed water quality is a TOC of 0.5 ppm and an acidic sugar rejection ratio of 72% in Comparative Example 3. That is, TOC shows an identical value but only the acidic sugar rejection ratio shows different values of 80% and 72%.

Likewise, Embodiment 4 and Comparative Example 6, those being the cases of using a polyacrylic acid aqueous solution of 0.1% concentration as a polymer coagulant aqueous solution and setting pH at 3.7, are examined. Whereas the particle size distribution (d50) is 1.0 μm and the being processed water quality is a TOC 0.5 ppm and an acidic sugar rejection ratio of 82% in Embodiment 4, the particle size distribution (d50) is 1.1 μm and the being processed water quality is a TOC of 0.5 ppm and an acidic sugar rejection ratio of 75% in Comparative Example 6. TOC shows an identical value but only the acidic sugar rejection ratio shows different values of 82% and 75%.

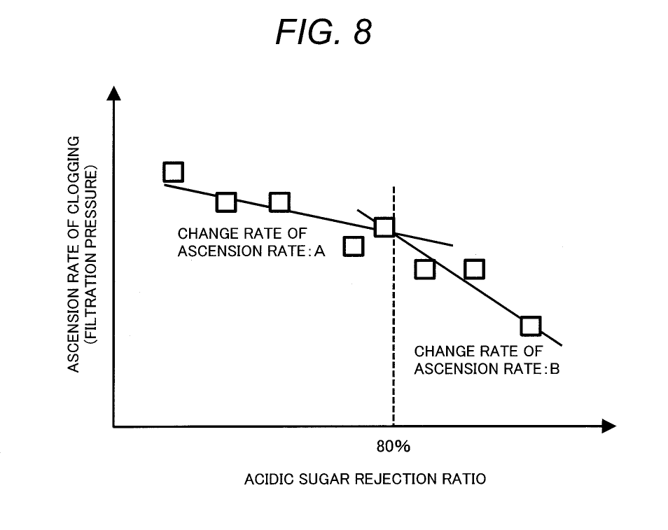

Attention is paid here to an acidic sugar rejection ratio and it is found that, when a water processing apparatus shown in FIG. 2 that is one of the embodiments according to the present invention is operated, the load in a second coagulation tank 11 and an RO membrane unit 10 installed at the rear stage of a filtration section 9 varies largely between above and below an acidic sugar rejection ratio of 80%. That is, the change rate of clogging (filtration pressure rise) speed of a membrane is correlated with an acidic sugar rejection ratio and varies largely between above and below an acidic sugar rejection ratio of 80%. FIG. 8 is a graph showing the relationship between an acidic sugar rejection ratio and an ascension rate of clogging (filtration pressure). The results obtained by feeding several kinds of being processed water having different acidic sugar rejection ratios to an RO membrane unit 10 and obtaining and plotting the ascension rates of clogging (filtration pressure) on those occasions are shown in FIG. 8. As shown in FIG. 8, when an acidic sugar rejection ratio is less than 80%, the ascension rate of clogging shows a large value and the change rate A is small. In contrast, when an acidic sugar rejection ratio is not less than 80%, the ascension rate of clogging lowers rapidly and the change rate B is larger than the change rate A. That is, by controlling an acidic sugar rejection ratio to not less than 80%, the clogging prevention effect at an RO membrane unit 10 improves conspicuously. Consequently, it is obvious that it is possible to obtain a high clogging prevention effect by setting a median size (d50) in the particle size distribution of a coagulant aqueous solution at not more than 1.0 μm.

Further, the lower limit of a median size (d50) in the particle size distribution of a coagulant aqueous solution is set on the assumption that a polymer coagulant dissolves completely. That is, atoms constituting a polymer coagulant are three elements of C, H, and O and a lower limit median size of 1.4 nm is obtained by computing the length of a polymer and an area occupied by the polymer from the covalent radii of them. Consequently, it is desirable to set a median size in the particle size distribution of a polymer coagulant aqueous solution used in the present invention at not less than 1.4 nm to not more than 1.0 μm.

Furthermore, in comparison between Embodiment 1 and Embodiment 7, the median sizes (d50) in the particle size distributions of the polymer coagulant aqueous solutions are an identical value of 1.0 μm but only pH is different and is 5.1 in Embodiment 1 and 1.0 in Embodiment 7. Whereas the being processed water quality is a TOC of 0.5 ppm and an acidic sugar rejection ratio of 80% in Embodiment 1, the being processed water quality is a TOC of 0.5 ppm and an acidic sugar rejection ratio of 83% in Embodiment 7.

Moreover, in comparison between Embodiment 4 and Embodiment 8, the median sizes (d50) in the particle size distributions of the polymer coagulant aqueous solutions are an identical value of 1.0 μm but only pH is different and is 3.7 in Embodiment 4 and 1.0 in Embodiment 8. Whereas the being processed water quality is a TOC of 0.5 ppm and an acidic sugar rejection ratio of 82% in Embodiment 4, the being processed water quality is a TOC of 0.4 ppm and an acidic sugar rejection ratio of 86% in Embodiment 8.

In this way, it is possible to obtain a clogging prevention effect in an RO membrane unit 10 installed at a rear stage as stated above by controlling a median size (d50) in the particle size distribution of a polymer coagulant aqueous solution used in the present invention to not more than 1.0 μm, and further improve an acidic sugar rejection ratio and the clogging prevention effect by lowering the pH of the polymer coagulant aqueous solution (in an acidic state). Here, it is preferable to adjust pH so as to be not more than 1.0 by adding a pH adjuster.

Here, the present invention is not limited to the configurations of the embodiments described above and includes various modified examples. For example, the embodiments are the examples explained in detail in order to explain the present invention in an understandable way, and are not always limited to embodiments including all the configurations explained above. Further, it is also possible to replace a part of a configuration in an embodiment with the configuration of another embodiment, or add the configuration of another embodiment to the configuration of an embodiment. Furthermore, it is also possible to add, delete, and replace the configuration of another embodiment with regard to a part of the configuration of each of the embodiments.

### EXPLANATIONS OF REFERENCE NUMERALS

1 Coagulant aqueous solution storage tank
2 Flow cell
3 Laser irradiation section
4 Detection section
5 Stirrer
6 Coagulant addition rate control section
7 First water quality inspection section
8 Second water quality inspection section
9 Filtration section
10 RO membrane unit
11 Coagulation tank
20 Branched channel for particle size distribution measurement
50 Particle size distribution measurement device
101 In-line mixer

1. A coagulation processing method for removing impurities from being processed water containing the impurities, comprising:
a step for adding one or plural kinds of coagulant aqueous solutions to said being processed water containing the impurities; and
a step for forming a coagulation
wherein a median size in the particle size distribution of said one or plural coagulant aqueous solutions is not more than 1.0 μm.

2. A coagulation processing method according to claim 1, wherein a coagulation is formed by adding an inorganic coagulant aqueous solution to said being processed water, and a polymer coagulant aqueous solution is added to said being processed water after said coagulation is formed.

3. A coagulation processing method according to claim 2, wherein said median size in said particle size distribution of said polymer coagulant aqueous solution is in the range of not less than 1.4 nm to not more than 1.0 μm.

4. A coagulation processing method according to claim 1, wherein pH of said coagulant aqueous solution is adjusted to not more than 1.0.

5. A coagulation processing method according to claim 1, wherein an addition quantity of said coagulant aqueous solution is decided on the basis of water quality data of said being processed water and said median size in said particle size distribution of said coagulant aqueous solution.

6. A coagulation processing method according to claim 2, wherein said inorganic coagulant aqueous solution is any one of aluminum sulphate, ferric chloride, ferric sulfate, aluminum chloride, aluminum sulfate, and polyaluminum chloride.

7. A coagulation processing method according to claim 2, wherein said polymer coagulant aqueous solution is any one of a polyacrylamide system coagulant, a polysulfonic acid system coagulant, a polyacrylic acid system coagulant, a polyacrylic acid ester system coagulant, polyamine system coagulant, and a polymethacrylic acid coagulant.

8. A coagulation processing method according to claim 5, wherein said water quality data of said being processed water includes at least any one of total organic carbon (TOC), turbidity, water temperature, pH, electroconductivity, protein, saccharide (neutral sugar, acidic sugar), and adenosine triphosphate (ATP) activity.

9. A coagulation processing unit comprising:
a coagulant aqueous solution storage tank having a stirrer, which stores a coagulant aqueous solution;
a particle size distribution measurement device which measures a particle size distribution of said coagulant aqueous solution in said coagulant aqueous solution storage tank;
a coagulation tank which mixes being processed water with an added coagulant aqueous solution, and form a coagulation;
a coagulation removing section which removes said coagulation from said being processed water containing said coagulation; and
a control section which controls said stirrer so that a median size in said particle size distribution of said coagulant aqueous solution may be not more than 1.0 μm on the basis of a measured particle size distribution.

10. A coagulation processing unit according to claim 9,
wherein said coagulant aqueous solution is an aqueous solution of an anionic polymer coagulant.

11. A coagulation processing unit according to claim 9, further comprising:
a water quality inspection section which measures quality of said being the processed water;
wherein said control section decides a quantity of said coagulant aqueous solution added to said being processed water on the basis of said measured quality of said being processed water and a particle size distribution obtained from said particle size distribution measurement device.

12. A coagulation processing unit according to claim 11,
wherein said water quality inspection section includes a first water quality inspection section which measures quality of said being processed water and a second water quality inspection section which measures quality of said being processed water from which the coagulation is removed, and
said control section decides a quantity of said coagulant aqueous solution added to said being processed water on the basis of the measurement results obtained from said first water quality inspection section, said second water quality inspection section, and said particle size distribution measurement device.

13. A coagulation processing unit according to claim 9,
wherein said coagulant aqueous solution storage tank includes a first storage tank to store an inorganic coagulant aqueous solution and a second storage tank to store a polymer coagulant aqueous solution, and
said coagulation tank includes a first coagulation tank to mix said inorganic coagulant aqueous solution introduced from said first storage tank with said being processed water and a second coagulation tank installed at the rear stage of said first coagulation tank to mix said being processed water containing said coagulation introduced from said first coagulation tank with said polymer coagulant aqueous solution introduced from said second storage tank.

14. A water processing apparatus comprising:
a coagulant aqueous solution storage tank having a stirrer, which stores a coagulant aqueous solution;
a particle size distribution measurement device which measures the particle size distribution of said coagulant aqueous solution in said coagulant aqueous solution storage tank;
a coagulation tank which mixes being processed water with an added coagulant aqueous solution and form a coagulation;
a coagulation removing section which removes said coagulation from said being processed water containing said coagulation;
a separation section which applies membrane separation processing to said being processed water introduced from said coagulation removing section; and
a control section which controls said stirrer so that a median size in the particle size distribution of said coagulant aqueous solution may be not more than 1.0 μm on the basis of a measured particle size distribution.

15. A water processing apparatus according to claim 14,
wherein said being processed water is seawater and said coagulant aqueous solution is an aqueous solution of an anionic polymer coagulant, and
said separation section has a reverse osmosis membrane (RO membrane) and separates concentrated water of a high saline concentration from fresh water by said reverse osmosis membrane.

16. A water processing apparatus according to claim 14, wherein said control section controls a stirring speed of said stirrer so that a median size in the particle size distribution of said coagulant aqueous solution may be in the range of not more than 1.0 μm.

17. A water processing apparatus according to claim 15, wherein a pH adjuster is added so that the pH of said coagulant aqueous solution in said coagulant aqueous solution storage tank may be not more than 1.0.

18. A coagulation processing method according to claim 2, wherein an addition quantity of said coagulant aqueous solution is decided on the basis of water quality data of said being processed water and said median size in said particle size distribution of said coagulant aqueous solution.

19. A coagulation processing method according to claim 3, wherein an addition quantity of said coagulant aqueous solution is decided on the basis of water quality data of said being processed water and said median size in said particle size distribution of said coagulant aqueous solution.

20. A coagulation processing method according to claim 3, wherein said inorganic coagulant aqueous solution is any one of aluminum sulphate, ferric chloride, ferric sulfate, aluminum chloride, aluminum sulfate, and polyaluminum chloride.

21. A coagulation processing method according to claim 3, wherein said polymer coagulant aqueous solution is any one of a polyacrylamide system coagulant, a polysulfonic acid system coagulant, a polyacrylic acid system coagulant, a polyacrylic acid ester system coagulant, polyamine system coagulant, and a polymethacrylic acid coagulant.

22. A coagulation processing unit according to claim 11,
wherein said coagulant aqueous solution storage tank includes a first storage tank to store an inorganic coagulant aqueous solution and a second storage tank to store a polymer coagulant aqueous solution, and
said coagulation tank includes a first coagulation tank to mix said inorganic coagulant aqueous solution introduced from said first storage tank with said being processed water and a second coagulation tank installed at the rear stage of said first coagulation tank to mix said being processed water containing said coagulation introduced from said first coagulation tank with said polymer coagulant aqueous solution introduced from said second storage tank.
